(19) United States
(12) Patent Application Publication
(10) Pub. No.: US 2014/0023582 A1
(43) Pub. Date: Jan. 23, 2014

(54) PHOTOSENSITIZERS AND USE THEREOF FOR GENERATING HYDROGEN FROM WATER

(71) Applicants: Stefan Nordhoff, Recklinghausen (DE); Uwe Dingerdissen, Seeheim (DE); Jens Busse, Bochum (DE); Sascha Hoch, Bochum (DE); Matthias Blug, Witten (DE); Horst-Werner Zanthoff, Muelheim a.d. Ruhr (DE); Felix Gaertner, Haltern am See (DE); Daniela Cozzula, Aachen (DE); Stefania Denurra, Sassari (IT); Anilkumar Gopinathan, Kottayam District (IN); Sebastian Losse, Glis (CH); Henrik Junge, Rostock (DE); Serafino Gladiali, Sassari (IT); Matthias Beller, Nienhagen (DE)

(72) Inventors: Stefan Nordhoff, Recklinghausen (DE); Uwe Dingerdissen, Seeheim (DE); Jens Busse, Bochum (DE); Sascha Hoch, Bochum (DE); Matthias Blug, Witten (DE); Horst-Werner Zanthoff, Muelheim a.d. Ruhr (DE); Felix Gaertner, Haltern am See (DE); Daniela Cozzula, Aachen (DE); Stefania Denurra, Sassari (IT); Anilkumar Gopinathan, Kottayam District (IN); Sebastian Losse, Glis (CH); Henrik Junge, Rostock (DE); Serafino Gladiali, Sassari (IT); Matthias Beller, Nienhagen (DE)

(73) Assignee: Evonik Degussa GmbH, Essen (DE)

(21) Appl. No.: 13/988,431

(22) PCT Filed: Oct. 28, 2011
(86) PCT No.: PCT/EP11/69031

§ 371 Date: Oct. 8, 2013

(30) Foreign Application Priority Data
Nov. 19, 2010 (DE) 10 2010 044 155.4

(51) Int. Cl. C07F 15/00; C01B 3/04

(52) U.S. Cl. CPC C07F 15/0033; C01B 3/042
USPC 423/658.2; 546/2; 502/155

(57) ABSTRACT

The invention relates to novel complexes and to the use thereof as photosensitizers for generating hydrogen from water.

The present invention relates to novel complexes and their use as photosensitizers for producing hydrogen from water.

Alternative energy generation, for example wind power or solar energy, are playing an increasingly important role in the worldwide supply of energy. The associated fluctuation in the quantity of energy provided requires the use of energy stores for bridging energy minimum phases (night, lack of wind, etc.). Hydrogen is in this context considered to be a promising energy store.

In addition, hydrogen is a valuable starting material for the preparation of a wide variety of important basic chemicals, e.g. ammonia and methanol, and specialty chemicals which can be prepared by hydrogenation. A future hurdle for the chemical utilization of hydrogen is that the industrial preparation of hydrogen by means of reforming processes is at present still largely based on fossil fuels. An important objective is to utilize the virtually limitless quantity of solar energy available for producing hydrogen. The most attractive appeal is the use of water as hydrogen source because water is available in virtually unlimited amounts. However, there are at present no processes which can be carried out economically.

The photocatalytic production of hydrogen from water described below occurs primarily in homogeneous solution by means of a catalyst system which generally comprises five components:
a) a photosensitizer
b) a water reduction catalyst
c) an electron donor
d) one or more solvents
e) water

Examples of photosensitizers are known from the literature, for example Goldsmith et al. J. Am. Chem. Soc., 2005, 127, 7502-7510. These are generally bipyridyl complexes of iridium (e.g. Cline et al. Inorg. Chem., 2008. 47, 10378-10388, Tinker et al. Chem. Eur. J. 2007. 13, 8726-8732, Zhang et al. Dalton Trans. 2010, 39, 1204-1206).

The efficiency of the known systems is not sufficient for effective utilization for production of hydrogen from water. For this reason, there is a need for improved photosensitizers.

It is therefore an object of the present invention to provide new photosensitizers and their use for production of hydrogen from water.

The present invention therefore firstly provides compounds of the formula (I)

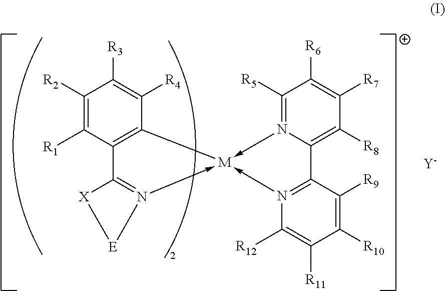

where M=iridium or ruthenium(II) and X is NR, O or S and E can be selected from among

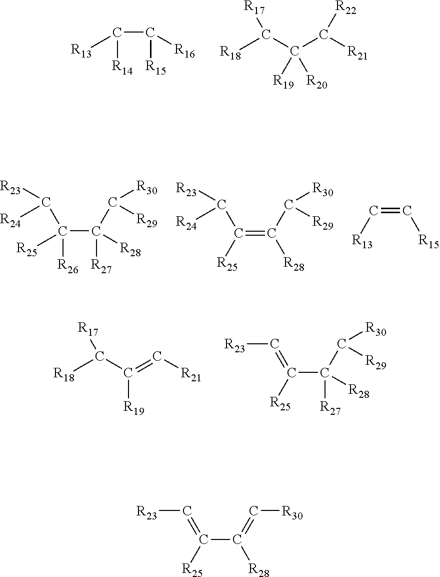

where R and R¹ to R³⁰ are each, independently of one another, hydrogen, halogen, straight-chain or branched alkyl having 1-20 carbon atoms, straight-chain or branched alkenyl having 2-20 carbon atoms and one or more double bonds, straight-chain or branched alkynyl having 2-20 carbon atoms and one or more triple bonds, saturated, partially or fully unsaturated cycloalkyl which has 3-7 carbon atoms and may be substituted by alkyl groups having 1-6 carbon atoms and the substituents R¹ to R³⁰ can be joined to one another in pairs by a single or double bond to form aromatic or aliphatic rings and a carbon atom or two nonadjacent carbon atoms of one or more substituents R¹ to R³⁰ can be replaced by atoms and/or atom groups selected from the group consisting of —O—, —C(O)—, —C (O) O—, —S—, —S (O)—, —SO₂—,—SO₃—, —N═, —N═N—, —NH—, —NR′—, —PR′—, —P(O) R′—, —P (O) R′—O—, —O—P (O) R′—O—and —P(R′)₂═N—, where R′ is unfluorinated, partially fluorinated or perfluorinated alkyl having 1-6 carbon atoms, saturated or partially unsaturated cycloalkyl having 3-7 carbon atoms, unsubstituted or substituted phenyl or an unsubstituted or substituted heterocycle, and Y⁻is a monovalent anion.

Suitable metals M in the formula (I) are iridium and ruthenium, with preference being given to using iridium.

According to the invention, possible substituents R¹ to R³⁰ are, apart from hydrogen: halides, in particular fluoride, chloride and bromide, C1-C20-, in particular C1-C6-alkyl groups and saturated or unsaturated, i.e. including aromatic, C3-C7-cycloalkyl groups, in particular phenyl. The substituents can be identical or different.

The C1-C6-alkyl group is, for example, methyl, ethyl, isopropyl, propyl, butyl, sec-butyl or tert-butyl, also pentyl, 1-, 2- or 3-methylbutyl, 1,1-, 1,2- or 2,2-dimethylpropyl, 1-ethylpropyl or hexyl.

Saturated or partially or fully unsaturated cycloalkyl groups having 3-7 carbon atoms are, for example, cyclopropyl, cyclobutyl, cyclopentyl, cyclohexyl, cycloheptyl, cyclopentenyl, cyclopenta-1,3-dienyl, cyclohexenyl, cyclohexa-1,3-dienyl, cyclohexa-1,4-dienyl, phenyl, cycloheptenyl, cyclohepta-1,3-dienyl, cyclohepta-1,4-dienyl or cyclohepta-1,5-dienyl, which may be substituted by C1-C6-alkyl groups.

In the substituents, a carbon atom or two nonadjacent carbon atoms of one or more substituents R¹ to R³⁰ can be replaced by atoms and/or atom groups selected from the group consisting of —O—,—C (O)—,—C (O) O—,—S—, —S (O)—,—SO₂—,—SO₃—,—N═,—N═N—,—NH—, —NR′—,—PR′—,—P (O) R′—,—P (O) R′—O—,—O—P (O) R′—O—, and —P(R′)₂═N—, where R′ =unfluorinated, partially fluorinated or perfluorinated C1-C6-alkyl, C3-C7-cycloalkyl, unsubstituted or substituted phenyl.

Without restricting the generality, examples of substituents modified in this way are —OCH₃, —OCH(CH₃)₂, —CH₂OCH₃, —CH₂—CH₂—O—CH₃, —C₂H₄OCH(CH₃)₂, —C₂H₄SC₂H₅, —C₂H₄SCH(CH₃)₂, —S(O)CH₃, —SO₂CH₃, —SO₂C₆H₅, —SO₂C₃H₇, —SO₂CH(CH₃)₂, —SO₂CH₂CF₃, —CH₂SO₂CH₃, —O—C₄H₈—O—C₄H₉, —CF₃, —C₂F₅, —C₃F₇, —C₄F₉, —C(CF₃)₃, —CF₂SO₂CF₃, —C₂F₄N(C₂F₅)C₂F₅, —CHF₂, —CH₂CF₃, —C₂F₂H₃, —C₃FH₆, —CH₂C₃F₇, —C(CFH₂)₃, —CH₂C(O)OH, —CH₂C₆H₅, —C(O)C₆H₅ or P(O)(C₂H₅)₂.

In R′, C3-C7-cycloalkyl is, for example, cyclopropyl, cyclobutyl, cyclopentyl, cyclohexyl or cycloheptyl.

In R′, substituted phenyl is phenyl substituted by C1-C6-alkyl, C1-C6-alkenyl, —CN, —NO₂, F, Cl, Br, I, —OH, —C1-C6-alkoxy, NR″₂, —COOH, —SO₂X′, —SR″, —S(O)R″, —SO₂R″, SO₂NR″₂ or SO₃H, where X is F, Cl or Br and R″ is an unfluorinated, partially fluorinated or perfluorinated C1-C6-alkyl or C3-C7-cycloalkyl as defined for R′, for example o-, m- or p-methylphenyl, o-, m- or p-ethylphenyl, o-, m- or p-propylphenyl, o-, m- or p-isopropylphenyl, o-, m- or p- tert-butylphenyl, o-, m- or p-nitrophenyl, o-, m- or p-hydroxyphenyl, o-, m- or p-methoxyphenyl, o-, m- or p-ethoxyphenyl, o-, m-, p-(trifluoromethyl)phenyl, o-, m-, p-(trifluoromethoxy)phenyl, o-, m-, p-(trifluoromethyl-sulfonyl)phenyl, o-, m- or p-fluorophenyl, o-, m- or p-chlorophenyl, o-, m- or p- bromo-phenyl, o-, m- or p-iodophenyl, more preferably 2,3-, 2,4-, 2,5-, 2,6-, 3,4- or 3,5-dimethylphenyl, 2,3-, 2,4-, 2,5-, 2,6-, 3,4- or 3,5-dihydroxyphenyl, 2,3-, 2,4-, 2,5-, 2,6-, 3,4- or 3,5-difluorophenyl, 2,3-, 2,4-, 2,5-, 2,6-, 3,4- or 3,5-dichlorophenyl, 2,3-, 2,4-, 2,5-, 2,6-, 3,4- or 3,5-dibromophenyl, 2,3-, 2,4-, 2,5-, 2,6-, 3,4- or 3,5-dimethoxy-phenyl, 5-fluoro-2-methylphenyl, 3,4,5-trimethoxyphenyl or 2,4,5-trimethylphenyl.

The anion Y⁻is a monovalent anion, in particular a weakly coordinating or noncoordinating anion, for example halides, PX₆⁻, BX₄⁻, B(Ar)₄⁻(Ar: aromatic radical), triflate and mesylate anions. The halide anions X can be selected from among fluoride, chloride, bromide and iodide anions, preferably from among fluoride, chloride and bromide anions.

The anion PF₆⁻ is particularly preferred.

The structural constituent E can be selected from among

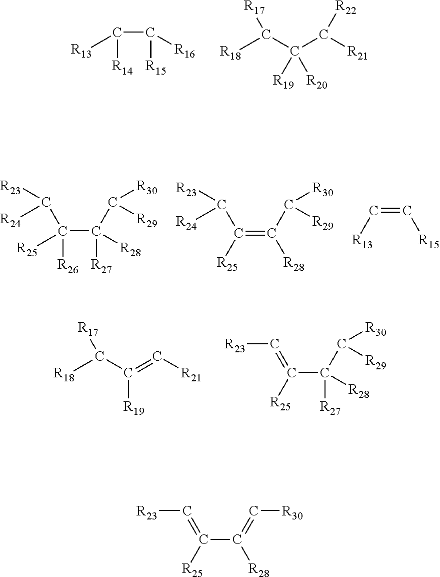

i.e. a 5- to 7-membered heterocyclic ring is present in formula (I).

Particular preference is given to a 5- or 6-membered ring being present, i.e. E is selected from among

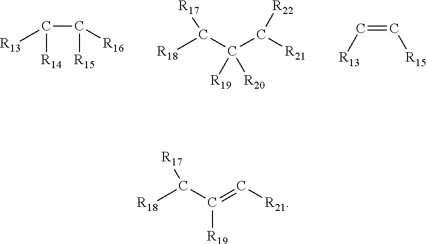

Very particular preference is given to E being selected from among

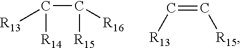

i.e. a 5-membered heterocycle is present in formula (I).

Particularly preferred compounds of the formula (I) thus have the following basic structure:

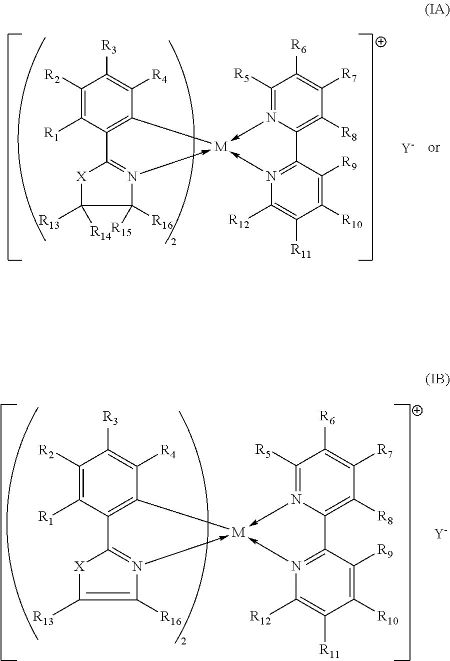

In the structures (IA) and (IB), the radicals R¹ to R¹⁶ can have the meanings indicated above.

M is particularly preferably iridium. Furthermore, X is preferably oxygen or sulfur, R¹ to R³⁰ are preferably hydrogen, halogen, straight-chain or branched alkyl having 1-20 carbon atoms, phenyl or the substituents R¹ to R³⁰ are joined to one another in pairs by a single or double bond to form aromatic or aliphatic rings. Y is preferably PF₆.

Particularly preferred compounds for the purposes of the present invention are therefore those of the formulae (II) to (VIII)

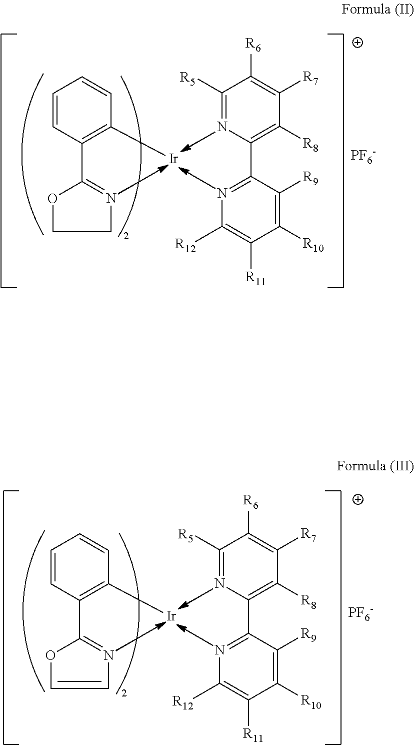

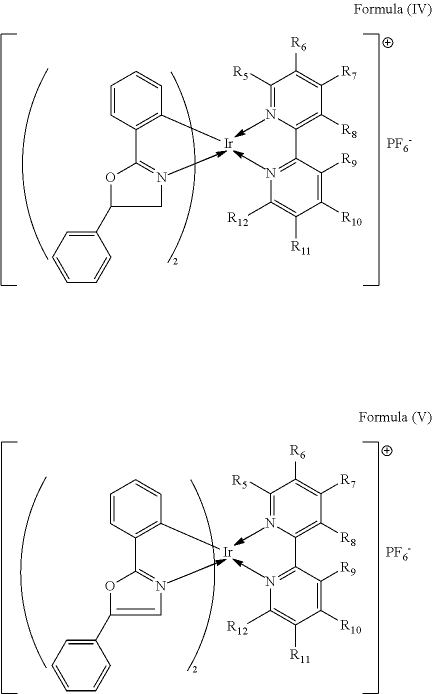

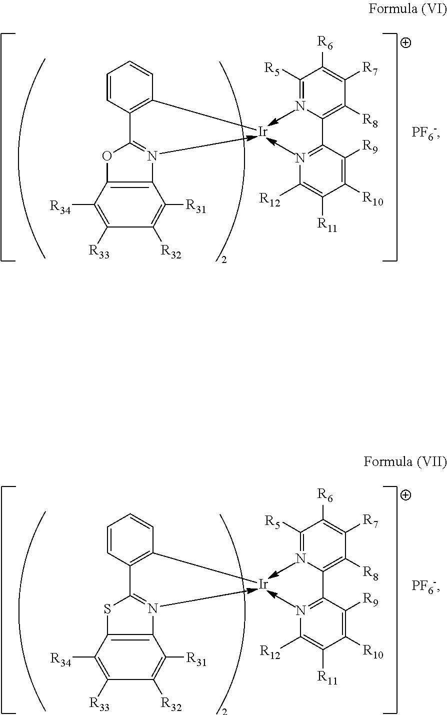

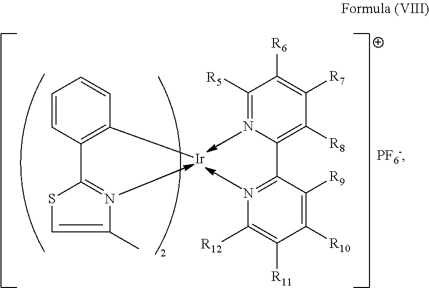

where R⁵ to R¹² are particularly preferably each hydrogen and R³¹ to R³⁴ are hydrogen or C1-C6-alkyl groups.

The present invention likewise provides processes for preparing the compounds mentioned. The complexes of the invention can in principle be obtained in a simple way. Preference is given to reacting an appropriate metal salt with the ligands, with the reaction being able to be carried out in one or more stages. The reaction is preferably carried out in a plurality of stages, in particular two stages. Here, the metal salt is reacted with the heteroazo ligand in a first stage. For this purpose, a mixture of a heteroazo ligand and a metal salt is typically heated in a mixture of an alcohol and water under reflux, forming a precipitate. The intermediate which is obtained as a dimer can be isolated by filtration and subsequent washing with diethyl ether. In the second stage, the isolated intermediate is reacted with bipyridyl to form the complexes according to the invention. For this purpose, a mixture of the intermediate and one equivalent of bipyridyl is generally dissolved in a mixture of ethanol and dichloromethane and stirred at room temperature for 24 hours.

Organic impurities are removed by extraction of the resulting suspension with diethyl ether and the product is precipitated from the aqueous phase by slow addition of an ammonium hexafluorophosphate solution. The compound according to the invention can be obtained as pure substance by filtration and subsequent washing of the filtercake with diethyl ether.

Such methods of preparing the compounds of the invention are described, for example, in Coppo et al. Chem. Commun. 2004, 1774-1775, Lowry et al., Chemistry of Materials, 2005, 17, 5712-5719.

The abovementioned compounds of the formulae (I) to (VIII) are particularly useful in catalytic processes, in particular as photosensitizers.

The present invention therefore further provides for the use of the compounds of the invention as catalyst or as constituent in catalyst systems, in particular as photosensitizer.

Particularly when used as photosensitizer in catalyst systems, the compounds of the invention are suitable for use in the production of hydrogen from water.

Catalyst systems comprising at least the compounds of the invention are likewise provided by the present invention.

In the catalyst systems mentioned, further components, in particular water reduction catalysts, solvents, water and electron donors, are generally present.

Suitable water reduction catalysts are the transition metals of transition groups 7 to 10, in particular Mn, Re, Fe, Ru, Co, Rh, Ir, Ni, Pd, Pt, preferably iron-containing complexes, in particular [HNEt₃][HFe₃(CO)₁₁], Fe₃(CO)₁₂, Fe(CO)₅, Fe₂(CO)₉, Fe(COT)(CO)₃ (COT: cyclooctatetraene), Fe₂(S₂)(CO)₆ complexes, but also Mn₂(CO)₁₀, K₂PtCl, Na₂PdCl₄, Ni(OAc)₂, Co(OAc)₂, also in combination with dmg ligands (dmg=dimethylglyoxime), RhCl₃or [Rh(bpy)₃](PF₆)₃.

Particular preference is given to using [HNEt₃][HFe₃(CO)₁₁], Fe₃(CO)₁₂, Fe(CO)₅, Fe₂(CO)₉, Fe(COT)(CO)₃ (COT: cyclooctatetraene), Fe₂(S₂)(CO)₆ complexes.

Furthermore, the catalyst system contains polar, preferably aprotic solvents. The solvents are particularly preferably miscible with water. It is possible to use, inter alia, ethers, nitriles and formamides for this purpose. Preference is given to using tetrahydrofuran, acetonitrile or dimethylformamide, with very particular preference being given to the solvent tetrahydrofuran (THF).

Electron donors used are reducing agents which are well known to those skilled in the art, e.g. alcohols, preferably methanol, amines, ascorbic acid. Preference is given to amines, in particular triethylamine.

Water as hydrogen source can be used in distilled form, undistilled form or with salt contents of 0.01-10% by weight.

The percentages of the various liquid components in the total volume are preferably as follows:
Water: 0.01-30% by volume, in particular 10-25% by volume,
Solvent: 99.8-30% by volume, in particular 30-60% by volume,
Electron donor: 0.1-60% by volume, in particular 25-50% by volume,
where the sum of the individual components is 100% by volume.
Particular preference is given to using a mixture of tetrahydrofuran/triethylamine/water in a ratio of 3:2:1 or 4:1:1.

The photosensitizer and the water reduction catalyst are used in concentrations of 10⁻⁴ mmol/l-100 mmol/l. Concentrations of 0.01-2.0 mmol/l are preferred for the photosensitizer and water reduction catalyst.

Processes for preparing hydrogen by reduction of water, in which a catalyst system comprising at least a compound according to the present invention is used, are likewise provided by the present invention.

The conditions for the production of hydrogen from water are known to those skilled in the art from the literature. The water reduction catalyst and photosensitizer are preferably dissolved under a protective gas atmosphere (nitrogen or argon) in the previously mixed solvent mixture (e.g. 10 ml, generally containing solvent, water and electron donor). The reaction solution is subsequently irradiated and hydrogen generation commences. The measurement of the volume is carried out by means of automatic or manual gas burettes (see, for example, Loges et al. Chemie Ingenieur Technik 2007, 79, 6, 741-753). The reaction temperature is 0° C.-100° C., preferably 20° C.-40° C. Particular preference is given to reactions at room temperature (25° C.). Suitable light sources are both natural solar radiation and also synthetic light sources of any type, for example mercury vapor lamps, xenon lamps or LEDs. The radiation used has, in particular, wavelengths in the range 300 nm-800 nm, preferably from 400 nm to 600 nm.

In this way, an improved process for preparing hydrogen is provided. Hydrogen obtained by the abovementioned process is thus likewise provided by the present invention.

Even without provision of further details, it is assumed that a person skilled in the art can utilize the above description in its widest scope. The preferred embodiments and examples are therefore to be interpreted merely as descriptive but in no way limiting disclosure. In particular, the compounds shown in the formulae are not restricted in respect of the stereoisomerism, i.e. further stereoisomers of the compounds of the invention are also encompassed by the present invention.

The present invention will be illustrated below with the aid of examples. Alternative embodiments of the present invention can be obtained in an analogous way.

### EXAMPLES

1. Preparation of tetrakis(2,5-diphenyloxazole)-μ-(dichloro)diiridium(III)

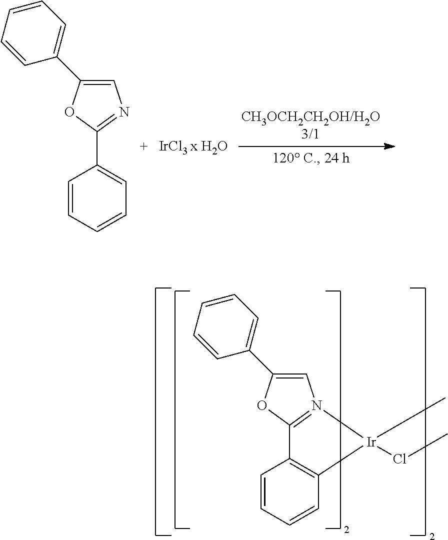

A mixture consisting of 2,5-diphenyloxazole (2.0 eq., typically 1.0 mmol), iridium(III) chloride (1.0 eq., 0.5 mmol) was heated in a mixture of methoxyethanol and water (3/1, 22 ml) under reflux (120° C.) for 24 hours. The precipitate formed was isolated by filtration and washed with diethyl ether. The target compound was obtained as a clean yellow powder in a yield of 63%.

2. Preparation of [(2,2′-bipy)bis(2,5-diphenyloxazole)iridium(III)]hexafluorophosphate

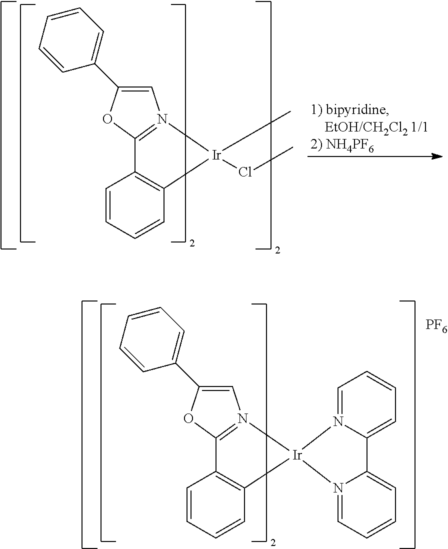

The dichloro-bridged dimer is dissolved together with 2,2′-bipyridine in a 1:1 mixture of ethanol/dichloromethane. The mixture is stirred at room temperature for 24 hours. The suspension formed is transferred with the aid of water into a separating funnel and the aqueous phase is washed with diethyl ether (3×50 ml). Residues of ether are subsequently boiled away at 45° C. for 20 minutes and the aqueous solution is cooled by means of an ice bath. Slow addition of a solution of ammonium hexafluorophosphate (1 g in 3 ml) gives a yellow to brown suspension. The solid is isolated by filtration and washed with water and diethyl ether. The target compound is in this way isolated as a yellow powder in a yield of 74%.

3. Preparation of [(2,2′-bipy)bis(2-phenyl-4,5-dihydrooxazole)iridium(III)]hexafluorophosphate

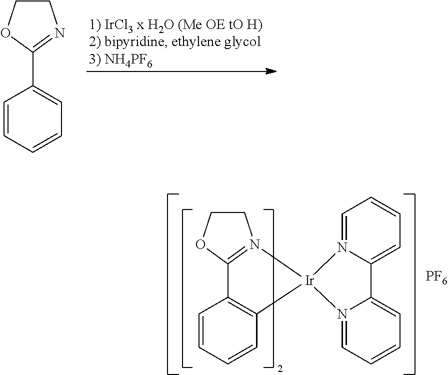

2-Phenyl-4,5-dihydrooxazole (0.3 ml) and IrCl₃xH₂O (312 mg) are suspended together in 8 ml of 2-methoxyethanol and 1 ml of water and the mixture is heated at 120° C. for 14 hours. The precipitate formed is filtered off and used without further purification for the second stage.

The solid from the first stage (100 mg) dissolved in ethylene glycol (6 ml) and bipyridine (33 mg) are heated at 150° C. for 24 hours. The reaction mixture is subsequently cooled to room temperature and transferred together with 60 ml of water to a separating funnel. The aqueous phase is washed with 3×20 ml of hexane and subsequently heated at 85° C. for 5 minutes.
The product is precipitated as an orange-brown solid by addition of NH₄PF₆ (1.0 g in 10 ml of water), washed with water and hexane and dried under reduced pressure.
4. Preparation of [(2,2′-bipy)bis(2-phenylbenzoxazole)iridium(III)]hexafluorophosphate

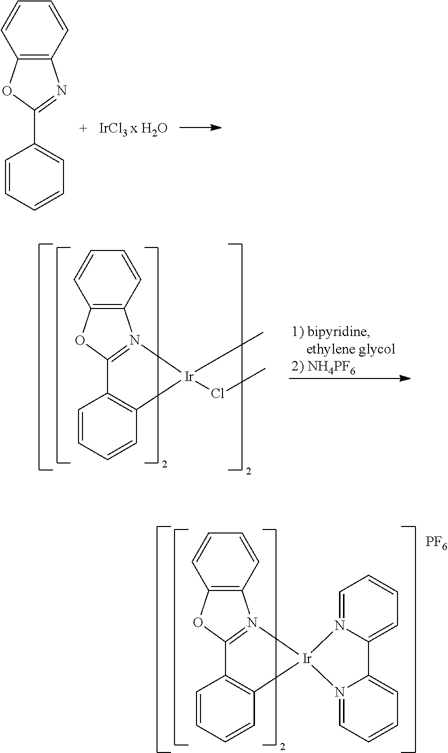

A mixture consisting of 2-phenylbenzoxazole (2.0 eq., typically 1.0 mmol), iridium(III) chloride (1.0 eq., 0.5 mmol) was heated in a mixture of methoxyethanol and water (3/1, 22 ml) under reflux (120° C.) for 24 hours. The precipitate formed was isolated by filtration and washed with diethyl ether. The intermediate (dichloro-bridged dimer) was obtained in the form of a yellow solid.

The intermediate product (0.5 eq, 0.5 mmol) is suspended together with 2,2″-bipyridine (1.0 eq, 1 mmol) in ethylene glycol (6 ml) and the mixture is heated at 150° C. for 16 hours. After cooling to room temperature, water (60 ml) is added to the reaction solution and the aqueous phase is extracted 3 times with diethyl ether (20 ml). Residues of ether remaining in the aqueous phase are boiled away by brief heating to 85° C. for 5 minutes. The product is precipitated by addition of aqueous ammonium hexafluorophosphate solution (1.0 g in 10 ml of water), washed with water and diethyl ether and subsequently dried under reduced pressure. The target compound is isolated in this way as a yellow powder in a yield of 29%.
5. Preparation of [(2,2′-bipy)bis(2-phenylbenzothiazole)iridium(III)]hexafluorophosphate

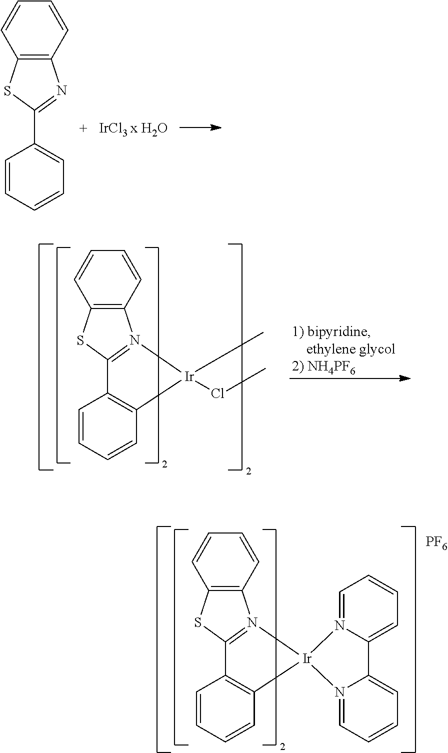

A mixture consisting of 2-phenylbenzothiazole (2.0 eq., typically 1.0 mmol), iridium(III) chloride (1.0 eq., 0.5 mmol) was heated in a mixture of methoxyethanol and water (3/1, 22 ml) under reflux (120° C.) for 24 hours. The precipitate formed was isolated by filtration and washed with diethyl ether. The intermediate (dichloro-bridged dimer) was obtained in the form of a yellow solid.

The intermediate product (0.5 eq, 0.5 mmol) is dissolved together with 2,2″-bipyridine (1.0 eq, 1 mmol) in a 1:1 mixture of ethanol/dichloromethane. The mixture is stirred at room temperature for 24 hours. All solvents are subsequently removed under reduced pressure and the remaining orange-colored residue is dissolved in water (60 ml). The aqueous phase is washed with diethyl ether (3×20 ml) and the product is subsequently precipitated by addition of an aqueous ammonium hexafluorophosphate solution (1.0 g in 10 ml of water). The solid is filtered off, washed with water and diethyl ether and dried under reduced pressure. The target compound is isolated in this way as a yellow powder in a yield of 57%.
6. Preparation of [(2,2′-bipy)bis(4-methyl-2-phenylthiazole)iridium(III)]hexafluorophosphate

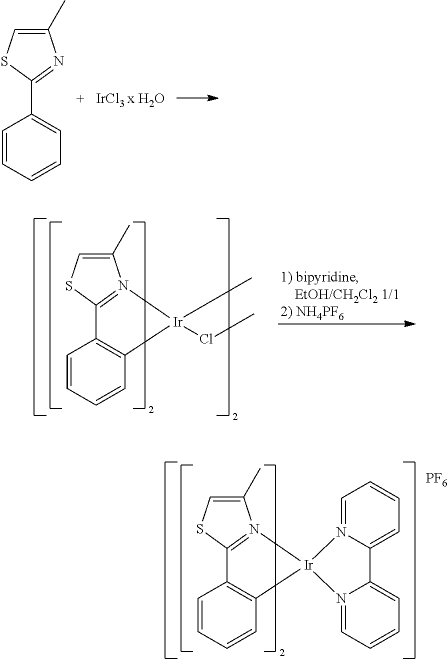

A mixture consisting of 4-methyl-2-phenylthiazole (2.0 eq., typically 1.0 mmol), iridium(III) chloride (1.0 eq., 0.5 mmol) was heated in a mixture of methoxyethanol and water (3/1, 22 ml) under reflux (120° C.) for 24 hours. The precipitate formed was isolated by filtration and washed with diethyl ether. The intermediate (dichloro-bridged dimer) was obtained in the form of a yellow solid.

The intermediate product (0.5 eq, 0.5 mmol) is dissolved together with 2,2″-bipyridine (1.0 eq, 1 mmol) in a 1:1 mixture of ethanol/dichloromethane. The mixture is stirred at room temperature for 24 hours. All solvents are subsequently removed under reduced pressure and the remaining orange-colored residue is dissolved in water (60 ml). The aqueous phase is washed with diethyl ether (3×20 ml) and the product is subsequently precipitated by addition of an aqueous ammonium hexafluorophosphate solution (1.0 g in 10 ml of water). The solid is filtered off, washed with water and diethyl ether and dried under reduced pressure. The target compound is isolated in this way as a yellow powder in a yield of 60%.

7. Production of hydrogen from Water

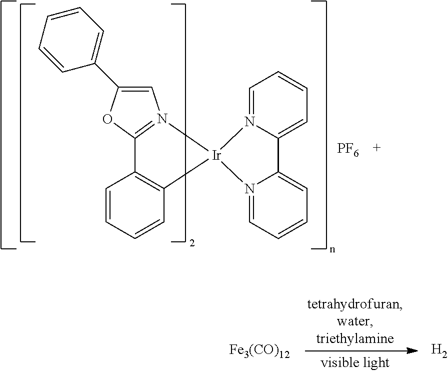

Source: F. Gärtner, B. Sundararaju, A.-E. Surkus, A. Boddien, B. Loges, H. Junge, P. H. Dixneuf, M. Beller Angew. Chem. 2009, 121, 10147-10150.

Typical catalysis experiment for the reduction of water:

A double-wall thermostated reaction vessel is made inert five times by means of vacuum and argon. The iridium sensitizer (7.5 mmol) and [Fe₃(CO)₁₂] (6.1 μmol) together with THF/triethylamine/H₂O (10 ml, 8:2:2) are subsequently introduced in Teflon dishes. As an alternative, stock solutions of the components can be used. After heating of the homogeneous reaction solution at 25° C. for 8 minutes, the reaction is started by irradiation.

The gases formed are collected by means of an automatic gas burette. The gases were analyzed by gas chromatography and quantified.

To determine the maximum turnover numbers, the experiments were each carried out twice and an average turnover number was calculated from the experiments. Here, the individual measurements differ from one another by from 1% to max. 10%. (Gas chromatograph HP 6890N, Carboxen 1000, TCD, external calibration). A 300 WXe lamp (300 watt) served as light source.

| | Structure of iridium | Hydrogen | Turnover number | Turnover number for water |
|---|---|---|---|---|
| Input | photosensitizer | [ml] | for photosensitizer | reduction catalyst |
| 1^{[a]} | 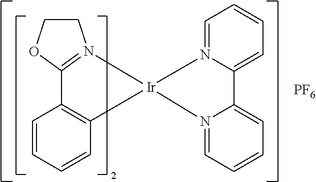 | 22 | 1300 | 150 |
| 2^{[a]} | 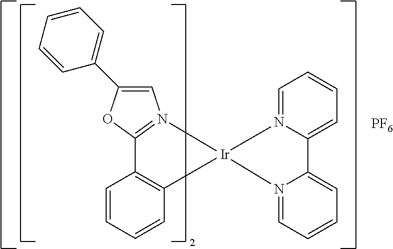 | 17 | 1000 | 110 |
| 3^{[b]} | 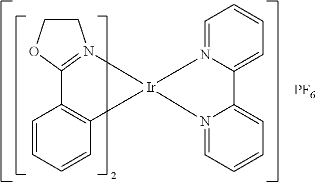 | 36 | 5900 | 440 |
| 4^{[a]} | 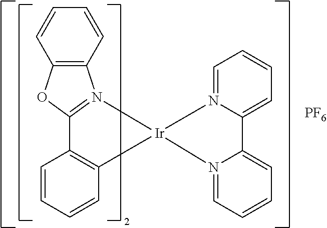 | 28 | 1600 | 180 |
| 5^{[a]} | 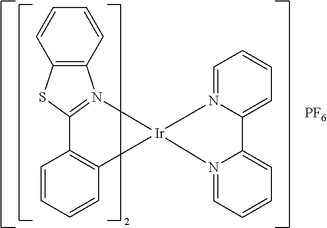 | 24 | 1400 | 160 |
| 6^{[a]} | 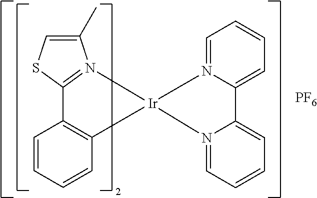 | 27 | 1500 | 170 |

^{[a]}Experimental conditions: 1.4 μmol of iridium photosensitizer, 6.1 μmol of [HNEt₃][HFe₃(CO)₁₁], 10 ml of THF/triethylamine/H₂O 8/2/2, Xe light irradiation (1.5 W radiation power), distance between light source and reaction vessel 10 cm, 25° C., 24 h.
^{[b]}experimental conditions: 0.5 μmol of iridium photosensitizer, 3.33 μmol of [HNEt₃][HFe₃(CO)₁₁], 20 ml of THF/triethylamine/H₂O 3/2/1, Xe light irradiation, distance between light source and reaction vessel 3 cm, 25° C., 7-24 h.

The examples show that the compounds of the invention make it possible to achieve photosensitizer productivities which cannot be achieved using systems known from the prior art (Beller et al. Ir-PS TON =3000).

1. A compound of the formula (I): 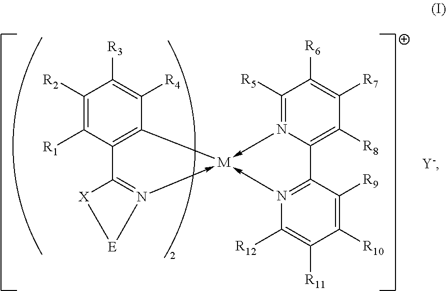
wherein:
M represents iridium or ruthenium;
X represents NR, O or S;
E is selected from the group consisting of: 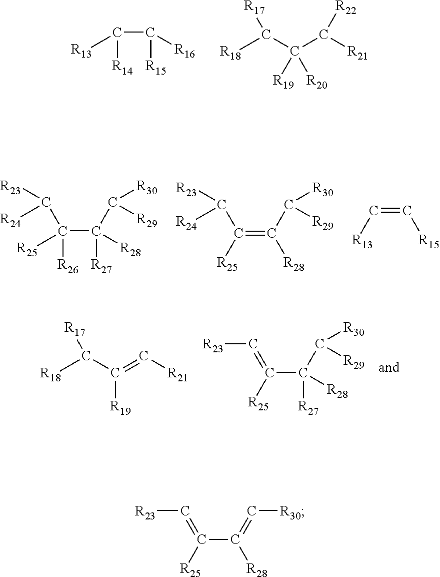
R and R¹ to R³⁰ each, independently of one another, represent hydrogen, halogen, straight-chain or branched alkyl having 1-20 carbon atoms, straight-chain or branched alkenyl having 2-20 carbon atoms and one or more double bonds, straight-chain or branched alkynyl having 2-20 carbon atoms and one or more triple bonds, saturated, partially or fully unsaturated cycloalkyl having 3-7 carbon atoms and optionally substituted by at least one alkyl group having 1-6 carbon atoms;
the substituents R¹ to R³⁰ are optionally joined to one another in pairs by a single or double bond to form aromatic or aliphatic rings;
a carbon atom or two nonadjacent carbon atoms of one or more substituents R¹ to R³¹ are optionally replaced by atoms and/or atom groups selected from the group consisting of —O—, —C(O)—, —C (O) O—, —S—, —S (O)—, —SO₂—,—SO₃—, —N═, —N═N—, —NH—, —NR′—, —PR′—, —P(O) R′—, —P (O) R′—O—, —O—P (O) R′—O—and —P(R′)₂═N—;
R′ represents unfluorinated, partially fluorinated or perfluorinated alkyl having 1-6 carbon atoms, saturated or partially unsaturated cycloalkyl having 3-7 carbon atoms, unsubstituted or substituted phenyl or an unsubstituted or substituted heterocycle; and
Y⁻ represents a monovalent anion.

2. The compound of in claim 1, wherein X is oxygen or sulfur.

3. The compound of claim 1, wherein:
E is: 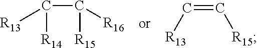
R₁₃ to R₁₆ each, independently of one another, represent hydrogen, halogen, Straight-chain or branched alkyl having 1-20 carbon atoms, straight-chain or branched alkenyl having 2-20 carbon atoms and one or more double bonds, straight-chain or branched alkynyl having 2-20 carbon atoms and one or more triple bonds, saturated, partially or fully unsaturated cycloalkyl having 3-7 carbon atoms and optionally substituted by at least one alkyl group having 1-6 carbon atoms;
the substituents R₁₃ to R₁₆ are optionally joined to one another in pairs by a single or double bond to form aromatic or aliphatic rings;
a carbon atom or two nonadjacent carbon atoms of one or more substituents R₁₃ to R₁₆ are optionally replaced by atoms and/or atom groups selected from the group consisting of —O—, —C(O)—, —C (O) O—, —S—, —S (O)—, —SO₂—,—SO₃—, —N═, —N═N—, —NH—, —NR′—, —PR′—, —P(O) R′—, —P (O) R′—O—, —O—P (O) R′—O—and —P(R′)₂═N—; and
R′ represents unfluorinated, partially fluorinated or perfluorinated alkyl having 1-6 carbon atoms, saturated or partially unsaturated cycloalkyl having 3-7 carbon atoms, unsubstituted or substituted phenyl or an unsubstituted or substituted heterocycle.

4. The compound of claim 1, wherein:
R¹ to R³⁰ each, independently, represent hydrogen, halogen, straight-chain or branched alkyl having 1-20 carbon atoms or phenyl; or
R¹ to R³⁰ are joined to one another in pairs by a single or double bond to form aromatic or aliphatic rings.

5. (canceled)

6. A catalyst system, comprising at least one compound of claim 1.

7. The catalyst system as claimed in claim 6, further comprising at least one water reduction catalyst and at least one electron donor.

8. A process for preparing hydrogen by reduction of water, the process comprising reducing water in the presence of the catalyst system of claim 6 to form hydrogen.

9. Hydrogen obtained by the process of claim 8.

10. The compound of claim 2, wherein:
E is: 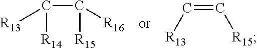
R₁₃ to R₁₆ each, independently of one another, represent hydrogen, halogen, Straight-chain or branched alkyl having 1-20 carbon atoms, straight-chain or branched alkenyl having 2-20 carbon atoms and one or more double bonds, straight-chain or branched alkynyl having 2-20 carbon atoms and one or more triple bonds, saturated, partially or fully unsaturated cycloalkyl having 3-7 carbon atoms and optionally substituted by at least one alkyl group having 1-6 carbon atoms;
the substituents R₁₃ to R₁₆ are optionally joined to one another in pairs by a single or double bond to form aromatic or aliphatic rings;
a carbon atom or two nonadjacent carbon atoms of one or more substituents R₁₃ to R₁₆ are optionally replaced by atoms and/or atom groups selected from the group consisting of —O—, —C(O)—, —C (O) O—, —S—, —S (O)—, —SO₂—,—SO₃—, —N═, —N═N—, —NH—, —NR′—, —PR′—, —P(O) R′—, —P (O) R′—O—, —O—P (O) R′—O—and —P(R′)₂═N—; and
R′ represents unfluorinated, partially fluorinated or perfluorinated alkyl having 1-6 carbon atoms, saturated or partially unsaturated cycloalkyl having 3-7 carbon atoms, unsubstituted or substituted phenyl or an unsubstituted or substituted heterocycle.

11. The compound of claim 2, wherein:
R¹ to R³⁰ each, independently, represent hydrogen, halogen, straight-chain or branched alkyl having 1-20 carbon atoms or phenyl; or
R¹ to R³⁰ are joined to one another in pairs by a single or double bond to form aromatic or aliphatic rings.
